(19) United States
(12) Patent Application Publication
(10) Pub. No.: US 2013/0024237 A1
(43) Pub. Date: Jan. 24, 2013

(54) MANAGEMENT DECISION MAKING SUPPORT SYSTEM

(71) Applicant: Seung-Tae Lee, Seoul (KR)

(72) Inventor: Seung-Tae Lee, Seoul (KR)

(21) Appl. No.: 13/483,548

(22) Filed: May 30, 2012

(30) Foreign Application Priority Data
Jul. 19, 2011 (KR) 10-2011-0071615

(51) Int. Cl. G06Q 10/06

(52) U.S. Cl. 705/7.25; 705/7.12

(57) ABSTRACT

A management decision making support system is provided. The management decision making support system analyzes an operational decision making problem for operational decision making and a strategic decision making problem for strategic decision making to evaluate individual business feasibility, generates a plurality of enterprise business portfolios combining individual businesses evaluated as feasible, and selects an optimal enterprise business portfolio by analyzing the generated enterprise business portfolios. Objective and standardized enterprise management consulting can be provided, reliability can be ensured, and rapidly changing management conditions can be effectively coped with.

### CROSS-REFERENCE TO RELATED APPLICATION

This application claims the priority under 35 U.S.C. §119(a) of Korean Patent Application No. 10-2011-0071615, filed on Jul. 19, 2011, the entire disclosure of which is incorporated herein by reference for all purposes.

### BACKGROUND

1. Field

The following description relates to an enterprise management support technique, and more particularly, to a management decision making support system that selects an optimal management scenario in a management decision making process required for the management of an enterprise, thereby contributing to reliable management of the enterprise.

2. Description of the Related Art

In Enterprise management consulting, handmade reports not only make it difficult to ensure that consulting results are reliable, but they are also make it impossible to effectively cope with rapidly changing management conditions and limit consulting to a one-time operation.

To overcome these limitations, Korea Patent No. 10-2010-0138232 (Dec. 31, 2010) to the present inventor discloses a technique that ensures reliable consulting results and effectively copes with the rapidly changing management conditions and provides objective and standardized consulting results by linking IT technology and consulting techniques.

Korea Patent No. 10-2010-0138232 deals with strategic decision making problems related to cost and finance, but in enterprise management decision making, operational decision making problems related to manufacturing capacity of products may be also an important factor, in addition to the strategic decision making problems related to cost and finance.

Accordingly, the inventor has conducted research on enterprise management support techniques which reflect operational decision making problems related to the manufacturing capacity of the product, as well as the strategic decision making problems related to cost and finance, in enterprise management decision making, thereby providing more reliable enterprise management consulting.

### SUMMARY

The following description relates to a management decision making support system that defines with software operational decision making problems and strategic decision making problems which are required for management decision making of an enterprise using IT techniques, and simulates with software solving methods for these problems to thereby enable objective and standardized management consulting.

In one general aspect, there is provided a management decision making support system which analyzes an operational decision making problem for operational decision making and a strategic decision making problem for strategic decision making to evaluate individual business feasibility, generates a plurality of enterprise business portfolios combining individual businesses evaluated as feasible, and analyzes the generated portfolios to thereby select an optimal enterprise business portfolio.

Other features and aspects will be apparent from the following detailed description, the drawings, and the claims.

### BRIEF DESCRIPTION OF THE DRAWINGS

FIG. 1 is a block diagram illustrating a configuration of an example of a management decision making support system according to an embodiment of the present invention;

FIG. 2 is a flowchart illustrating an example of determining a management decision making operation of a management decision making support system according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to accompanying drawings.

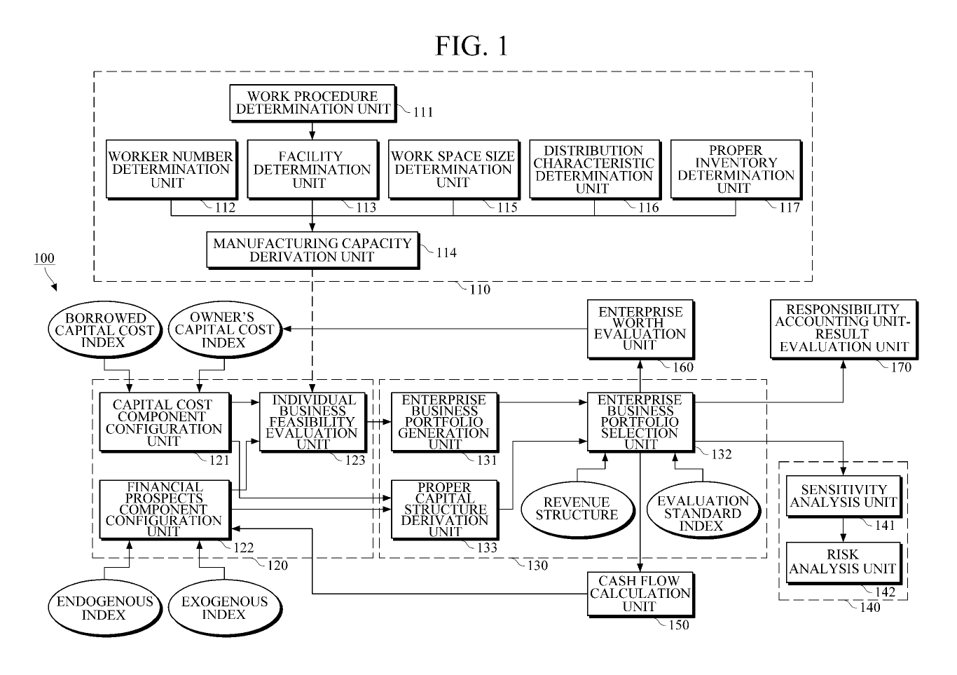

FIG. 1 is a block diagram illustrating a configuration of an example of a management decision making support system according to an embodiment of the present invention.

As shown in FIG. 1, a management decision making support system 100 according to the present embodiment includes an operational decision making simulation unit 110, a strategic decision making simulation unit 120, and an enterprise business simulation unit 130.

The operational decision making simulation unit 110 analyzes an operational decision making problem for operational decision making, and simulates and derives manufacturing capacity from the analysis result.

In this instance, the operational decision making problem may involve work procedure, number of workers, facilities, work space size, distribution characteristics, and proper inventory.

The strategic decision making simulation unit 120 analyzes the strategic decision making problem for strategic decision making, and simulates and evaluates individual business feasibility based on the analysis result and the manufacturing capacity derived by the operational decision making simulation unit 110.

In this instance, the strategic decision making problem may include a capital cost component and a financial prospects component.

The enterprise business simulation unit 130 generates a plurality of enterprise business portfolios combining individual businesses evaluated as feasible by the strategic decision making simulation unit 120, and analyzes the generated portfolios to thereby select an optimal enterprise business portfolio.

According to the present embodiment, by combining IT technology and consulting techniques to predict an operational outcome and result of a business process performed by an enterprise based on the operational decision making problem for operational decision making and the strategic decision making problem for strategic decision making, objective and standardized enterprise management consulting is provided, thereby ensuring reliability and effectively coping with rapidly changing management conditions.

Meanwhile, according to another embodiment of the present invention, the operational decision making simulation unit 110 may include a work procedure determination unit 111, a worker number determination unit 112, a facility determination unit 113, and a manufacturing capacity derivation unit 114.

The work procedure determination unit 111 determines a work procedure by sequentially arranging individual operations needed to manufacture products. The work procedure is an important operational decision making problem needed to ensure that product manufacturing proceeds smoothly. For example, the work procedure determination unit 111 provides a user interface (not shown) for determining the work procedure required for the manufacture of products, so that operations required for corresponding product production may be selected by a user, a performance order of the operations may be set, and the work procedure required for the manufacture of products may be determined.

The worker number determination unit 112 determines the number of workers required for the individual operations included in the work procedure determined by the work procedure determination unit 111. The number of workers is an important operational decision making problem required for determining a manufacturing amount of the products and work efficiency.

For example, the worker number determination unit 112 provides a user interface (not shown) for determining the number of workers required for the individual operations included in the work procedure, so that the number of workers required for the individual operations may be received from the user, and the number of workers required for the individual operations included in the work procedure determined by the work procedure determination unit 111 may be determined.

The facility determination unit 113 determines facilities required for the individual operations included in the work procedure determined by the work procedure determination unit 111. The facility is an important operational decision making problem required for determining a type of product manufacturing and work efficiency.

For example, the facility determination unit 113 provides a user interface (not shown) for determining the facilities required for the individual operations included in the work procedure, so that the facilities required for the individual operations may be selected by a user, and the facilities required for the individual operations included in the work procedure determined by the work procedure determination unit 111 may be determined.

The manufacturing capacity derivation unit 114 predicts a manufacturing amount of manufactured products to thereby derive a manufacturing capacity, when workers corresponding to the number of workers required for the individual operations determined by the worker number determination unit 112 operate the facilities required for the individual operations determined by the facility determination unit 113, and perform the individual operations in accordance with the work procedure determined by the work procedure determination unit 111.

For example, the manufacturing capacity derivation unit 114 calculates a maximum manufacturing amount in which products are maximally produced for a predetermined period of time when predicting the manufacturing amount of the products, thereby deriving the manufacturing capacity. An algorithm for predicting the manufacturing amount of the products is a typical technique which was known and performed in a variety of manners before this application, and therefore, detailed description thereof will be omitted.

Meanwhile, according to another embodiment of the present invention, the operational decision making simulation unit 110 further includes a work space size determination unit 115, a distribution characteristic determination unit 116, and a proper inventory determination unit 117.

The work space size determination unit 115 determines the work space size. The work space size is an important operational decision making problem required for determining a working environment provided for improving production efficiency of products. For example, the work space size determination unit 115 provides a user interface (not shown) for setting the work space size, through which setting of the work space size is received from a user, so that the work space size may be determined.

The distribution characteristic determination unit 116 determines the distribution characteristics required for the individual operations or derived from the individual operations. In this instance, the distribution characteristics may be weight, volume, material, transportation distance, and the like, and distribution is an important operational decision making problem required for reducing costs at the time of product manufacture.

For example, the distribution characteristic determination unit 116 provides a user interface (not shown) for setting the distribution characteristics required for the individual operations or derived from the individual operations, through which setting of the distribution required for the individual operations or derived from the individual operations is received from a user, so that characteristics of the selected distribution may be set, and the distribution characteristics required for the individual operations or derived from the individual operations may be determined.

The proper inventory determination unit 117 determines the proper inventory of the manufactured products. The proper inventory is an important operational decision making problem required for coping with unexpected uncertainty at the time of product manufacture.

For example, the proper inventory determination unit 117 provides a user interface (not shown) for setting a proper inventory quantity of the manufactured products, through which setting of the proper inventory of corresponding manufactured products is received from a user, so that the proper inventory of the corresponding manufactured products may be determined.

In this instance, the manufacturing capacity derivation unit 114 further reflects the work space size determined by the work space size determination unit 115, the distribution characteristics determined by the distribution characteristic determination unit 116, and the proper inventory determined by the proper inventory determination unit 117, to thereby predict the manufacturing amount of the manufactured products.

Accordingly, using the operational decision making simulation unit 110, the operational decision making problem for operational decision making such as the work procedure, the number of workers, the facilities, the work space size, the distribution characteristics, the proper inventory, and the like may be analyzed, and the manufacturing capacity may be simulated and derived from the analysis result.

Meanwhile, the manufacturing capacity derivation unit 114 simulates the manufacturing capacity to thereby derive an optimal manufacturing capacity while changing the work procedure set by the work procedure determination unit 111, the number of workers determined by the worker number determination unit 112, the facilities determined by the facility determination unit 113, the work space size determined by the work space size determination unit 115, the distribution characteristics determined by the distribution characteristic determination unit 116, the proper inventory determined by the proper inventory determination unit 117, and the like.

Meanwhile, according to another embodiment of the present invention, the strategic decision making simulation unit 120 may include a capital cost component configuration unit 121, a financial prospects component configuration unit 122, and an individual business feasibility evaluation unit 123.

The capital cost component configuration unit 121 receives a capital cost index to configure the capital cost component. In this instance, the capital cost index may include an owner's capital cost and a borrowed capital cost which are to be invested in the individual businesses. For example, the capital cost component configuration unit 121 provides a user interface (not shown) for a capital cost index input for calculating the owner's capital cost and the borrowed capital cost which are to be invested in the individual businesses, so that when inputting the capital cost index for calculating the owner's capital cost and the borrowed capital cost which are to be invested in the individual businesses by a user, the capital cost component configuration unit 121 may use the capital cost index as the capital cost component, and configure the capital cost component in which an input capital cost index value is used as a capital cost component value.

The financial prospects component configuration unit 122 receives an exogenous index and an endogenous index to configure the financial prospects component. For example, the financial prospects component configuration unit 122 provides a user interface (not shown) for inputting the exogenous index and the endogenous index, so that when the exogenous index and the endogenous index are input by a user, the financial prospects component configuration unit 122 may configure the financial prospects component based on the input exogenous index and the endogenous index.

In this instance, the exogenous index may be an external environmental factor, that is, a factor generated outside an enterprise. Here, the external environmental factor may include interest rates, oil prices, an exchange rate, an inflation rate, an economic growth rate, and an industrial growth rate, and may be reflected in the evaluation of individual business feasibility.

Meanwhile, the endogenous index may be an internal environmental factor, that is, a factor generated inside the enterprise. Here, the endogenous index may include a capital structure, an asset portfolio, man-power management, and a revenue structure, and may be reflected in the evaluation of individual business feasibility.

For example, when the exogenous index and the endogenous index are input, the financial prospects component configuration unit 122 may generate estimated financial statements such as an estimated income statement, an estimated balance sheet, an estimated cash flow table, and the like, and configure the financial prospects component in which an amount of estimated income, an amount of estimated balance, an amount of estimated cash flow, and the like are used as financial prospects component values.

The individual business feasibility evaluation unit 123 evaluates feasibility of each of the individual businesses based on the capital cost component configured by the capital cost component configuration unit 121, the financial prospects component configured by the financial prospects component configuration unit 122, and the manufacturing capacity derived by the operational decision making simulation unit 110. In this instance, the individual business feasibility evaluation unit 123 may evaluate the feasibility of each of the individual businesses for each type of business or for each business characteristic. That is, the individual business feasibility evaluation unit 123 evaluates feasibility concerning whether each of the individual businesses is performed when performing business using the manufacturing capacity derived by investing the capital cost, such as the owner's capital cost, the borrowed capital cost, and the like included in the capital cost component to each of the individual businesses, based on the financial prospects, such as the estimated income, the estimated balance, the estimated cash flow, and the like derived from the financial prospects component.

Accordingly, as described above, using the strategic decision making simulation unit 120, objective and standardized feasibility evaluation results with respect to each of the individual businesses based on the capital cost component, the financial prospects component, and the manufacturing capacity, may be obtained, thereby ensuring reliability.

Meanwhile, according to another embodiment of the present invention, the enterprise business simulation unit 130 may include an enterprise business portfolio generation unit 131 and an enterprise business portfolio selection unit 132.

The enterprise business portfolio generation unit 131 generates the plurality of enterprise business portfolios combining the individual businesses evaluated as feasible by the strategic decision making simulation unit 120. For example, when n-number of individual businesses are evaluated as feasible by the individual business feasibility evaluation unit 123 among m-number of individual businesses, the number of enterprise businesses into which the n-number of individual businesses can be combined is 2n-1, and 2n-1-number of enterprise business portfolios may be generated by the enterprise business portfolio generation unit 131.

For example, the enterprise businesses into which the individual businesses A, B, and C evaluated as feasible can be combined are (A), (B), (C), (A,B), (A,C), (B,C), and (A,B,C), and the enterprise business portfolio generation unit 131 may generate portfolios for the enterprise businesses (A), (B), (C), (A,B), (A,C), (B,C), and (A,B,C).

The enterprise business portfolio selection unit 132 simulates the enterprise business portfolios generated by the enterprise business portfolio generation unit using a capital structure derivation model stored in advance to thereby derive a capital structure of each of the enterprise business portfolios, and compares the derived capital structure of each of the enterprise business portfolios with a proper capital structure, to thereby select the optimal enterprise business portfolio.

The capital structure derivation model is data which defines information required for deriving the capital structure of the portfolio and describes a processing method of the defined information, and is stored in a database in advance.

The proper capital structure is an indicator indicating that a ratio of owner's capital to borrowed capital is an appropriate level.

In this instance, when selecting the optimal enterprise business portfolio, the enterprise business portfolio selection unit 132 analyzes a predicted revenue structure of each of the derived enterprise business portfolios, and further reflects an evaluation standard index including a predicted growth rate, to thereby select the optimal enterprise business portfolio.

For example, when 2n-1-number of enterprise business portfolios are generated by the enterprise business portfolio generation unit 131, the enterprise business portfolio selection unit 122 simulates each of the 2n-1-number of enterprise business portfolios using the capital structure derivation model to derive a capital structure of each of the enterprise business portfolios, and compares the derived capital structure of each of the enterprise business portfolios with the proper capital structure to thereby select an optimal enterprise business portfolio which has the best ratio of owner's capital to borrowed capital while satisfying a reference of the proper capital structure, or has a higher predicted growth rate.

Accordingly, as described above, using the enterprise business simulation unit 130, a predicted capital structure with respect to the plurality of enterprise business portfolios combining individual businesses evaluated as feasible by the strategic decision making simulation unit 120 may be analyzed, and an objective and standardized enterprise business portfolio may be selected, thereby ensuring reliability.

Meanwhile, according to another embodiment of the present invention, the enterprise business simulation unit 130 may further include a proper capital structure derivation unit 133.

The enterprise business simulation unit 130 derives the proper capital structure from the strategic decision making problem analysis result of the strategic decision making simulation unit 120.

That is, in the present embodiment, the proper capital structure derivation unit 133 derives the proper capital structure indicating that the ratio of owner's capital to borrowed capital is the appropriate level, using the capital cost component configured by the capital cost component configuration unit 121 and the financial prospects component configured by the financial prospects component configuration unit 122.

The proper capital structure derived by the proper capital structure derivation unit 133 may be referred to when selecting the optimal enterprise business portfolio by the enterprise business portfolio selection unit 132.

Meanwhile, according to another embodiment of the present invention, the management decision making support system 100 may further include a management strategy management unit 140. The management strategy management unit 140 analyzes a predicted risk when making projections based on the enterprise business portfolio selected by the enterprise business simulation unit 130, and corrects the corresponding enterprise business portfolio in accordance with the analyzed risk to thereby establish a management strategy. In this instance, the management strategy management unit 140 may include a sensitivity analysis unit 141 and a risk analysis unit 142.

The sensitivity analysis unit 141 analyzes sensitivity associated with environment index variation with respect to the enterprise business portfolio selected by the enterprise business simulation unit 130. For example, the sensitivity may be sales, earnings, cash flow, and variation in a debt ratio which are associated with the environment index variation.

The risk analysis unit 142 assumes variation of environment indexes in which the sensitivity associated with the environment index variation analyzed by the sensitivity analysis unit 141 is analyzed as being higher than a reference value to thereby generate a risk response scenario, and corrects the corresponding enterprise business portfolio in accordance with the generated risk response scenario.

For example, when the environment index variation such as interest rates, oil prices, an exchange rate, and the like is normalized from 0 to 100, and a reference value is assumed as being 70, the sensitivity associated with the environment index variation is analyzed using the sensitivity analysis unit 141, and variations of the environment indexes having higher sensitivity than the reference value are assumed to create the risk response scenario.

For example, in a case in which the interest rate, the exchange rate, and the oil price are selected as the environment indexes analyzed as having higher sensitivity than the reference value 70, when an interest rate of 5%, an increase of 10% in the exchange rate, and an increase of 10% in the oil price are expected going forward, the interest rate of 5%, the increase of 10% in the exchange rate, and the increase of 10% in the oil price are assumed with respect to the selected enterprise business portfolio to thereby create risk response scenarios such as reducing costs, reducing personnel, raising a unit sale price, and the like.

In this instance, the risk analysis unit 142 generates the risk response scenario associated with the assumed variation of the environment indexes for each risk stage. For example, a case in which an interest rate of 4%, an increase of 5% in the exchange rate, and an increase of 5% in the oil price are obtained is set as a risk stage 1, and a case in which an interest rate of 5%, an increase of 7% in the exchange rate, and an increase of 6% in the oil price are obtained is set as a risk stage 2. Here, when different risk response scenarios are generated for each risk stage, it is possible to more flexibly cope with the environment index variation.

Meanwhile, the risk analysis unit 142 adjusts an endogenous index value of the enterprise business portfolio in accordance with the generated risk response scenarios such as changing a budget, procuring additional funds, reducing a purchase unit price, raising a unit sale price, or the like, or corrects the corresponding enterprise business portfolio to thereby establish a management strategy. According to the present invention, the management strategy which can more flexibly cope with the predicted environment index variation may be established, thereby effectively coping with rapidly changing management conditions.

Meanwhile, according to another embodiment, the management decision making support system 100 may further include a cash flow calculation unit 150.

The cash flow calculation unit 150 calculates a cash flow margin and a procurement scale which are predicted by the enterprise business portfolio selected by the enterprise business simulation unit 130.

When the enterprise business portfolio is selected by the enterprise business simulation unit 130, the cash flow margin and the procurement scale which are predicted based on the corresponding enterprise business portfolio may be calculated based on the indexes such as the derived capital structure of the selected enterprise business portfolio, the predicted revenue structure, or the predicted growth rate, and the like, so that the cash flow margin and procurement scale may be predicted when the selected enterprise business is performed.

Meanwhile, according to another embodiment of the present invention, the management decision making support system 100 may further include an enterprise worth evaluation unit 160.

The enterprise worth evaluation unit 160 evaluates an enterprise worth which is predicted by the enterprise business portfolio selected by the enterprise business simulation unit 130.

When the enterprise business portfolio is selected by the enterprise business simulation unit 130, an enterprise worth which is predicted by the corresponding enterprise business portfolio may be evaluated based on the financial prospects and the capital structure of the corresponding selected enterprise business portfolio, so that a predicted enterprise value when the selected enterprise business is performed may be predicted.

Meanwhile, according to another embodiment of the present invention, the management decision making support system 100 may further include a responsibility accounting unit-result evaluation unit 170. The responsibility accounting unit-result evaluation unit 170 evaluates results such as profitability, growth, and the like, which are predicted for each responsibility accounting unit, for example, each business department, based on the enterprise business portfolio selected by the enterprise business simulation unit 130.

For example, a responsibility accounting unit to perform the enterprise business selected by the responsibility accounting unit-result evaluation unit 170 may be set, and a ratio of indexes to be reflected for each set responsibility accounting unit may be set to reflect the set ratio in a responsibility accounting unit-evaluation model, thereby evaluating the results such as profitability, growth, and the like which are predicted for each business department. Accordingly, when performing the enterprise business selected by the responsibility accounting unit-result evaluation unit 170, predicted results for each responsibility accounting unit may be evaluated.

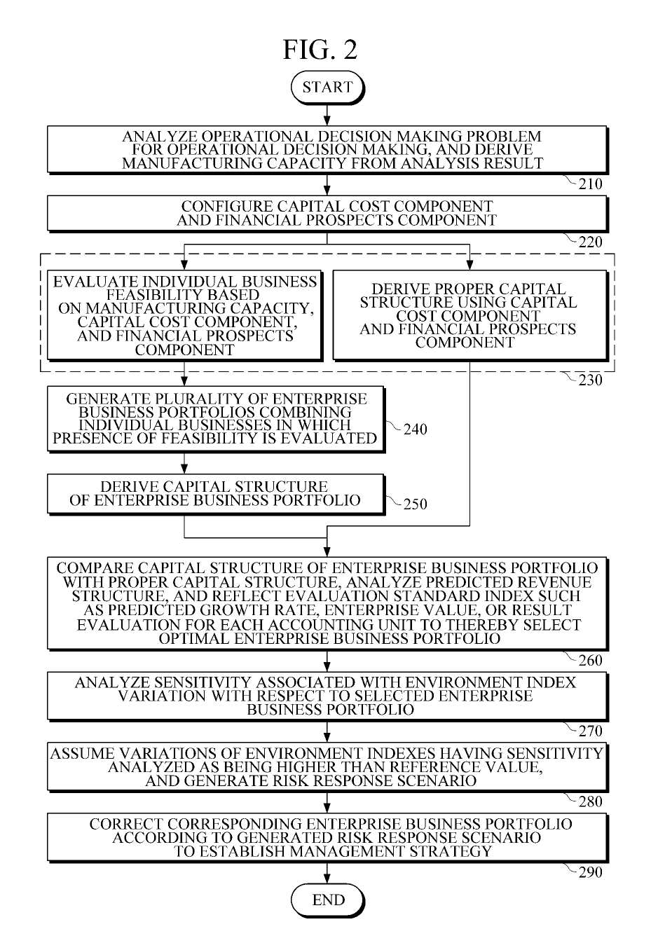

Hereinafter, a management decision making operation of the management decision making support system according to the present invention will be described with reference to FIG. 2. FIG. 2 is a flowchart illustrating an example of determining a management decision making operation of a management decision making support system according to an embodiment of the present invention.

Referring to FIG. 2, in operation 210, the management decision making support system analyzes an operational decision making problem for operational decision making involving work procedure, number of workers, work space size, distribution characteristics, and proper inventory, and derives manufacturing capacity from the analysis result. The manufacturing capacity has been described above and will not be described again here.

Next, in operation 220, the management decision making support system receives a capital cost index to configure a capital cost component, and receives an exogenous index and an endogenous index to configure a financial prospects component.

Next, in operation 230, the management decision making support system evaluates feasibility of individual businesses based on the manufacturing capacity derived in operation 210 and the capital cost component and the financial prospects component configured in operation 220, and derives a proper capital structure.

Next, in operation 240, the management decision making support system generates a plurality of enterprise business portfolios that combine the individual businesses evaluated as feasible in operation 230.

In operation 250, when the plurality of enterprise business portfolios are generated in operation 240, the management decision making support system simulates financial progress based on the generated enterprise business portfolios using a capital structure derivation model stored in advance to thereby derive a capital structure of each of the enterprise business portfolios.

In operation 260, when the capital structure of each of the enterprise business portfolios is derived, the management decision making support system compares the derived capital structure of each of the enterprise business portfolios with the proper capital structure to thereby select an optimal enterprise business portfolio.

Meanwhile, in operation 260, when selecting the optimal enterprise business portfolio, a predicted revenue structure of each of the derived enterprise business portfolios may be analyzed, and an evaluation standard index such as a predicted growth rate, and the like, the enterprise value, the result evaluation for each accounting unit, and the like may be reflected, thereby selecting the optimal enterprise business portfolio.

In this instance, a cash flow margin and a procurement scale which are predicted from the capital structure of the selected enterprise business portfolio may be calculated, and a predicted enterprise value or the result for each responsibility accounting unit may be evaluated.

In operation 270, when the optimal enterprise business portfolio is selected in operation 260, the management decision making support system analyzes sensitivity associated with environment index variation with respect to the enterprise business portfolio selected in operation 260.

Next, in operation 280, the management decision making support system assumes variation of environment indexes in which the sensitivity associated with the environment index variation analyzed in operation 270 is analyzed as being higher than a reference value to thereby generate a risk response scenario.

In operation 290, when the risk response scenario is generated in operation 280, the management decision making support system changes an endogenous index in accordance with the generated risk response scenario, or corrects the corresponding enterprise business portfolio in accordance with the generated risk response scenario to thereby establish a management strategy.

As described above, according to the present invention, IT technology and consulting techniques may be combined to evaluate feasibility of individual businesses based on manufacturing capacity, a capital cost component, and a financial prospects component. An optimal enterprise business portfolio may be selected from among a plurality of enterprise business portfolios combining individual businesses evaluated as feasible. Objective and standardized enterprise management consulting can be provided, reliability can be ensured, and rapidly changing management conditions can be effectively coped with.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A management decision making support system, comprising:
an operational decision making simulation unit that analyzes an operational decision making problem for operational decision making, and simulates and derives manufacturing capacity from the analysis result;
a strategic decision making simulation unit that analyzes a strategic decision making problem for strategic decision making, and simulates and evaluates individual business feasibility based on the analysis result and the manufacturing capacity derived by the operational decision making simulation unit; and
an enterprise business simulation unit that generates a plurality of enterprise business portfolios combining individual businesses evaluated as feasible by the strategic decision making simulation unit, and analyzes the generated portfolios to thereby select an optimal enterprise business portfolio.

2. The management decision making support system according to claim 1, wherein the operational decision making problem involves work procedure, number of workers, facilities, work space size, distribution characteristics, and proper inventory.

3. The management decision making support system according to claim 1, wherein the strategic decision making problem includes a capital cost component and a financial prospects component.

4. The management decision making support system according to claim 2, wherein the operational decision making simulation unit comprises:
a work procedure determination unit that determines a work procedure by sequentially arranging individual operations needed to manufacture products;
a worker number determination unit that determines a number of workers required for the individual operations included in the work procedure determined by the work procedure determination unit;
a facility determination unit that determines facilities required for the individual operations included in the work procedure determined by the work procedure determination unit; and
a manufacturing capacity derivation unit that predicts a manufacturing amount of manufactured products to derive a manufacturing capacity when workers corresponding to the number of workers required for the individual operations determined by the worker number determination unit operate the facilities required for the individual operations determined by the facility determination unit, and perform the individual operations in accordance with the work procedure determined by the work procedure determination unit.

5. The management decision making support system according to claim 4, wherein the operational decision making simulation unit further comprises:
a work space size determination unit that determines work space size;
a distribution characteristic determination unit that determines distribution characteristics required for the individual operations or derived from the individual operations; and
a proper inventory determination unit that determines a proper inventory of the manufactured products, and wherein
the manufacturing capacity derivation unit further reflects the work space size determined by the work space size determination unit, the distribution characteristics determined by the distribution characteristic determination unit, and the proper inventory determined by the proper inventory determination unit to thereby predict the manufacturing amount of the manufactured products.

6. The management decision making support system according to claim 3, wherein the strategic decision making simulation unit comprises:
a capital cost component configuration unit that receives a capital cost index to configure the capital cost component;
a financial prospects component configuration unit that receives an exogenous index and an endogenous index to configure the financial prospects component; and
an individual business feasibility evaluation unit that evaluates feasibility of each of the individual businesses based on the capital cost component configured by the capital cost component configuration unit, the financial prospects component configured by the financial prospects component configuration unit, and the manufacturing capacity derived by the operational decision making simulation unit.

7. The management decision making support system according to claim 6, wherein the individual business feasibility evaluation unit evaluates the feasibility of each of the individual businesses for each type of business or for each business characteristic.

8. The management decision making support system according to claim 1, wherein the enterprise business simulation unit comprises:
an enterprise business portfolio generation unit that generates the plurality of enterprise business portfolios combining the individual businesses evaluated as feasible by the strategic decision making simulation unit; and
an enterprise business portfolio selection unit that simulates the enterprise business portfolios generated by the enterprise business portfolio generation unit using a capital structure derivation model stored in advance to thereby derive a capital structure of each of the enterprise business portfolios, and compares the derived capital structure of each of the enterprise business portfolios with a proper capital structure to thereby select the optimal enterprise business portfolio.

9. The management decision making support system according to claim 8, wherein, when selecting the optimal enterprise business portfolio, the enterprise business portfolio selection unit analyzes a predicted revenue structure of each of the derived enterprise business portfolios, and further reflects an evaluation standard index including a predicted growth rate to thereby select the optimal enterprise business portfolio.

10. The management decision making support system according to claim 8, wherein the enterprise business simulation unit further comprises:
a proper capital structure derivation unit that derives the proper capital structure from the strategic decision making problem analysis result of the strategic decision making simulation unit.

11. The management decision making support system according to claim 1, further comprising:
a management strategy management unit that analyzes a predicted risk when performing the enterprise business portfolio selected by the enterprise business simulation unit, and corrects the corresponding enterprise business portfolio in accordance with the analyzed risk to thereby establish a management strategy.

12. The management decision making support system according to claim 11, wherein the management strategy management unit comprises:
a sensitivity analysis unit that analyzes sensitivity associated with environment index variation with respect to the enterprise business portfolio selected by the enterprise business simulation unit; and
a risk analysis unit that assumes variation of environment indexes in which the sensitivity associated with the environment index variation analyzed by the sensitivity analysis unit is analyzed as being higher than a reference value to thereby generate a risk response scenario, and corrects the corresponding enterprise business portfolio in accordance with the generated risk response scenario.

13. The management decision making support system according to claim 12, wherein the sensitivity is sales, earnings, cash flow, and variation in a debt ratio which are associated with the environment index variation.

14. The management decision making support system according to claim 12, wherein the risk analysis unit generates the risk response scenario associated with the assumed variation of the environment indexes for each risk stage.

15. The management decision making support system according to claim 1, further comprising:
a cash flow calculation unit that calculates a cash flow margin and a procurement scale which are predicted by the enterprise business portfolio selected by the enterprise business simulation unit.

16. The management decision making support system according to claim 1, further comprising:
an enterprise worth evaluation unit that evaluates an enterprise worth which is predicted by the enterprise business portfolio selected by the enterprise business simulation unit.

17. The management decision making support system according to claim 1, further comprising:
a responsibility accounting unit-result evaluation unit that evaluates a result for each responsibility accounting unit, which is predicted by the enterprise business portfolio selected by the enterprise business simulation unit.

18. The management decision making support system according to claim 6, wherein the capital cost index includes an owner's capital cost and a borrowed capital cost which are to be invested in the individual businesses.

19. The management decision making support system according to claim 6, wherein the exogenous index is an external environmental factor which includes interest rates, oil prices, exchange rates, inflation rates, economic growth rates, and industrial growth rates, and which is reflected in the evaluation of individual business feasibility.

20. The management decision making support system according to claim 6, wherein the endogenous index is an internal environmental factor which includes a capital structure, an asset portfolio, man-power management, and a revenue structure, and which is reflected in the evaluation of individual business feasibility.
